(19) United States
(12) Patent Application Publication
(10) Pub. No.: US 2019/0023464 A1
(43) Pub. Date: Jan. 24, 2019

(54) VENTED CONTAINER AND LID ASSEMBLY FOR PRODUCE

(71) Applicant: Enviro-Tex Products Inc., Paris (CA)

(72) Inventor: James Barrie Ogilvie, Paris (CA)

(73) Assignee: Enviro-Tex Products Inc., Paris (CA)

(21) Appl. No.: 15/654,628

(22) Filed: Jul. 19, 2017

(51) Int. Cl. B65D 51/16; A47J 47/10

(52) U.S. Cl. CPC B65D 51/1627; B65D 43/02; A47J 47/10

(57) ABSTRACT

A container and lid assembly comprises a container and a lid. The container comprises a base, and at least one container sidewall extends from the base to define and encircle an interior volume of the container and has a peripheral edge structure defining a lid engagement lip. The lid comprises a cover portion, which has a peripheral edge structure defining a container engagement channel about a perimeter thereof. The lid is releasably securable to the container by interengagement of the lid engagement lip in an interference fit within the container engagement channel. The lid engagement lip and/or the container engagement channel have at least one recessed portion so that when interengaged, the lid engagement lip to and the container engagement channel are spaced from one another at the recessed portion(s) to form at least one ventilation pathway between the interior volume of the container and ambient.

### TECHNICAL FIELD

The present disclosure relates to container assemblies for produce, and more particularly to container and lid assemblies for produce which require ventilation to extend their shelf life.

### BACKGROUND

Certain types of produce require ventilation to extend their shelf life. For example, mushrooms release carbon dioxide gas which, if retained in a container and lid assembly with the mushrooms instead of being vented to ambient, can harm the mushrooms and reduce their to shelf life.

### SUMMARY

In one aspect, a container and lid assembly comprises a container and a lid. The container comprises a base and at least one container sidewall extending generally superiorly from the base about a perimeter thereof to define and encircle an interior volume of the container. The container sidewalks) have a peripheral edge structure defining a lid engagement lip. The lid comprises a cover portion having a peripheral edge structure defining a container engagement channel about a perimeter thereof. The lid is releasably securable to the container by releasable interengagement of the lid engagement lip in an interference fit within the container engagement channel. For at least one of the lid engagement lip and the container engagement channel, at least one perimetrically extending portion is recessed so that, when the lid engagement lip is interengaged with the container engagement channel, the lid engagement lip and the container engagement channel are spaced from one another at each such perimetrically extending recessed portion to thereby form at least one ventilation pathway between the interior volume of the container and ambient.

In some embodiments, the interference fit is achieved by way of a channel shoulder that projects inwardly into the container engagement channel, outwardly from the cover portion, to overlap a correspondingly positioned lip shoulder projecting inwardly relative to the container

In some embodiments, the ventilation pathway(s) include a circuitous, indirect, labyrinthine portion formed by respective shapes of the lid engagement lip and the container engagement channel.

In some embodiments, at least one portion of the perimetrically extending portion of the lid engagement lip is inwardly recessed.

In some embodiments, the perimeter of the base is generally rectangular and there are four container sidewalls joined by corners, and at least one portion of the perimetrically extending portion of the lid engagement lip is inwardly recessed on each container sidewall. In some such embodiments, the inwardly recessed perimetrically extending portions of the lid engagement lip on opposite container sidewalls are offset from one another. In certain particular embodiments, the container includes inwardly impressed strengthening columns on each container sidewall, and the inwardly recessed perimetrically extending portions of the lid engagement lip are in registration with the strengthening columns.

In some embodiments, the container is stackable on the lid. In certain particular embodiments, one of the cover portion and the base includes locating depressions and the other of the cover portion and the base includes correspondingly positioned locating projections, and the locating depressions are configured to receive the locating projections therewithin.

In some embodiments, the container is nestable within another of the containers.

The lid may include a ridge formed inwardly of the container engagement channel.

In another aspect, a container comprises a base and at least one container sidewall extending generally superiorly from the base about a perimeter thereof to define and encircle an interior volume of the container. The container sidewall(s) have a peripheral edge structure defining a lid engagement lip, and the container is releasably securable to a lid by releasable interengagement of the lid engagement lip in an interference fit within a container engagement channel on the lid. At least one portion of the perimetrically extending portion of the lid engagement lip is inwardly recessed so that, when the lid engagement lip is interengaged with the container engagement channel, the lid engagement lip and the container engagement channel are spaced from one another at each such perimetrically extending portion to thereby form at least one ventilation pathway between an interior volume of the container and ambient.

The container may be incorporated into a container and lid assembly further comprising a lid, wherein the lid comprises a cover portion and has a peripheral edge structure defining the container engagement channel about a perimeter thereof.\

In some embodiments, the perimeter of the base is generally rectangular and there are four container sidewalls joined by corners, and at least one portion of the perimetrically extending portion of the lid engagement lip is inwardly recessed on each container sidewall. In certain particular embodiments, the inwardly recessed perimetrically extending portions of the lid engagement lip on opposite container sidewalls are offset from one another. In some such embodiments, the container may include inwardly impressed strengthening columns on each container sidewall, and the inwardly recessed perimetrically extending portions of the lid engagement lip maybe in registration with the strengthening columns.

In some embodiments, the base of the container includes at least one of locating depressions and locating projections, and in particular embodiments the base of the container includes locating projections.

In some embodiments, the container is nestable within another of the containers.

### BRIEF DESCRIPTION OF THE DRAWINGS

These and other features will become more apparent from the following description in which reference is made to the appended drawings wherein:

FIG. 1 is a top perspective view of an exemplary container according to an aspect of the present disclosure;

FIG. 2 is a bottom perspective view of the container of FIG. 1;

FIG. 3 is a first side elevation view of the container of FIG. 1;

FIG. 4 is a second side elevation view of the container of FIG. 1;

FIG. 5 is a third side elevation view of the container of FIG. 1;

FIG. 6 is a fourth side elevation view of the container of FIG. 1;

FIG. 7 is a top plan view of the container of FIG. 1;

FIG. 8 is a bottom plan view of the container of FIG. 1;

FIG. 9 is a top perspective view of an exemplary lid according to an aspect of the present disclosure;

FIG. 10 is a bottom perspective view of the lid of FIG. 9;

FIG. 11 is a first side elevation view of the lid of FIG. 9;

FIG. 12 is a second side elevation view of the lid of FIG. 9;

FIG. 13 is a third side elevation view of the lid of FIG. 9;

FIG. 14 is a fourth side elevation view of the lid of FIG. 9;

FIG. 15 is a top plan view of the lid of FIG. 9;

FIG. 16 is a bottom plan view of the lid of FIG. 9;

FIG. 17 is a top perspective view of an exemplary container and lid assembly according to an aspect of the present disclosure, formed by securing the lid of FIG. 9 on the container of FIG. 1;

FIG. 18 is a top plan view of the container and lid assembly of FIG. 17;

FIG. 19 is a cross-sectional view of the container and lid assembly of FIG. 17, taken along the line 19-19 in FIG. 18; and

FIGS. 19A and 19B are detail views of portions of the cross-sectional view shown in FIG. 19.

### DETAILED DESCRIPTION

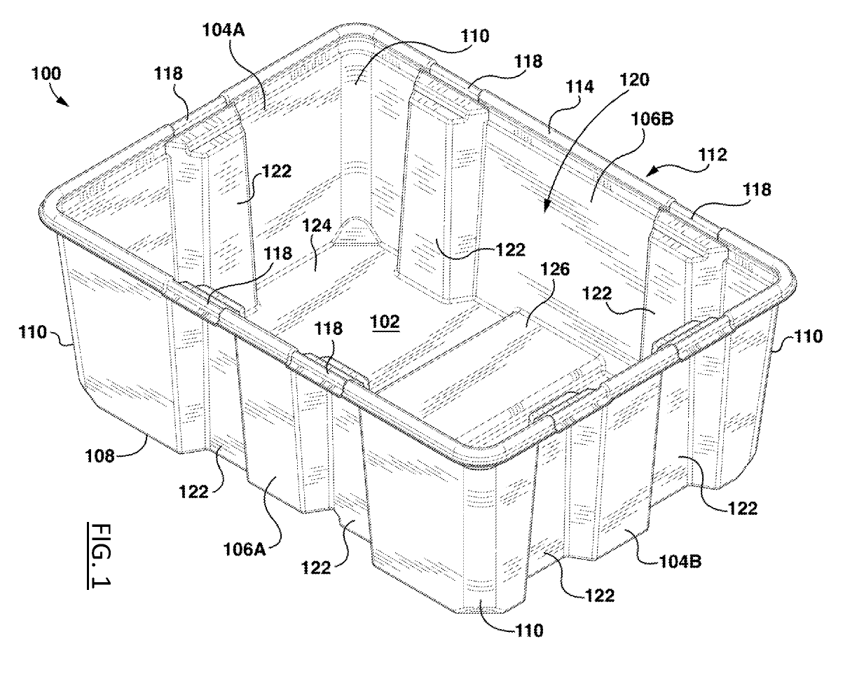

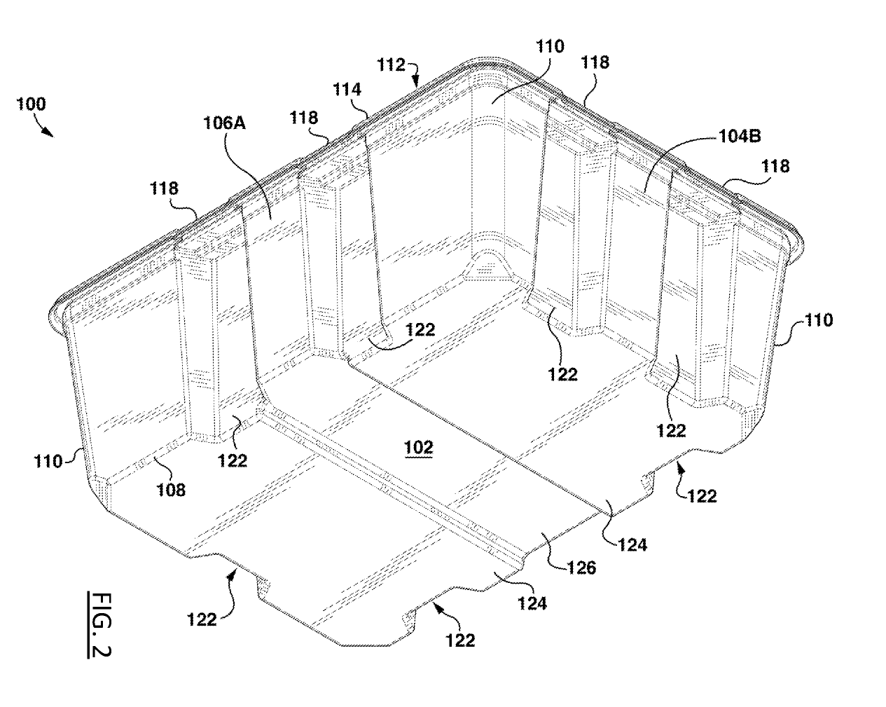

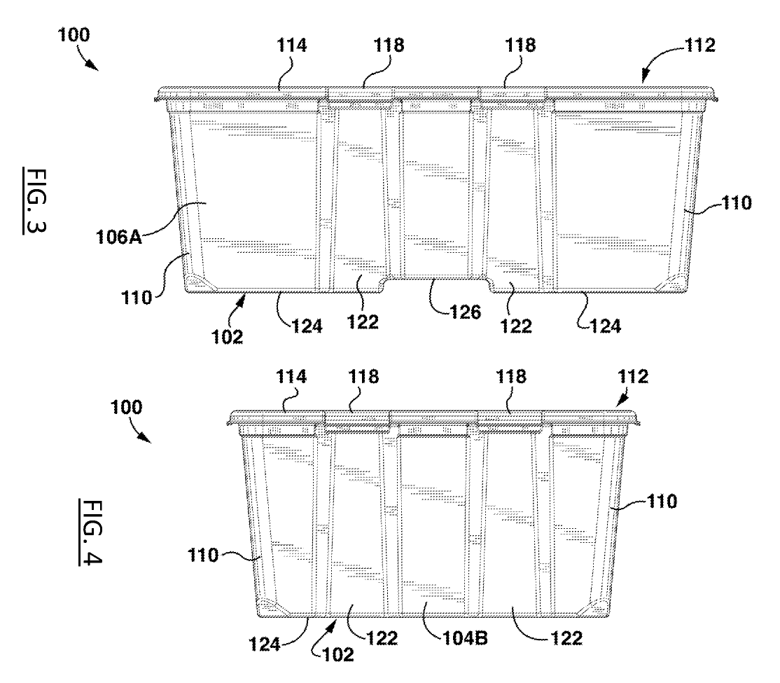

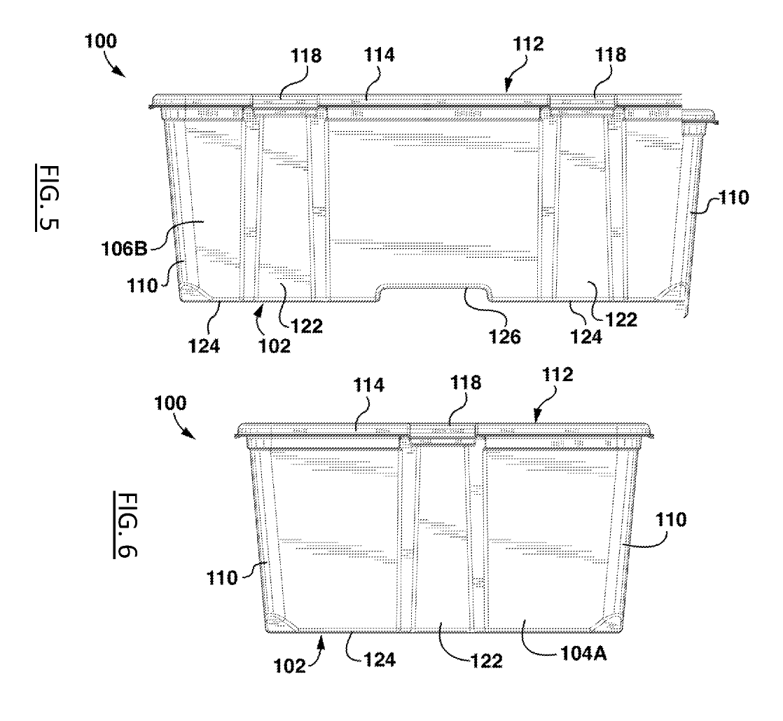

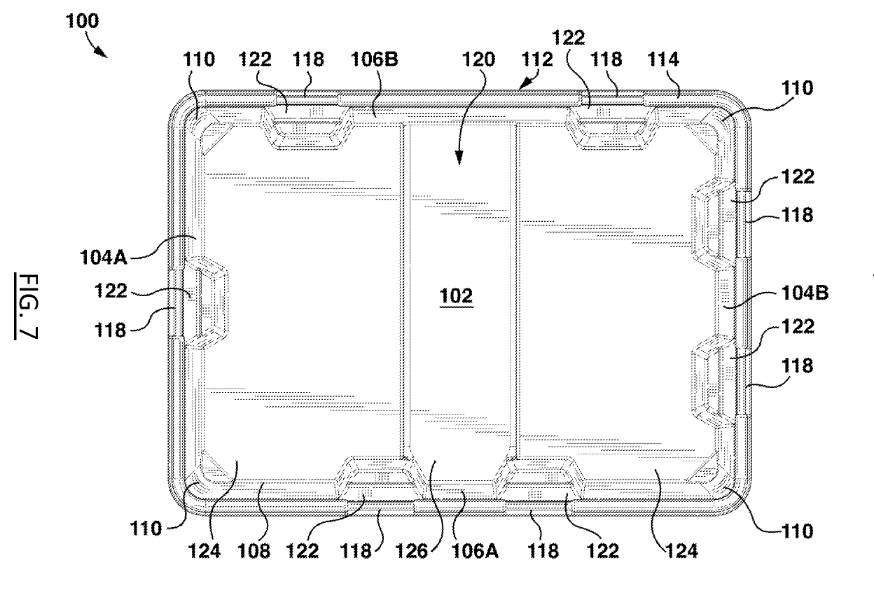

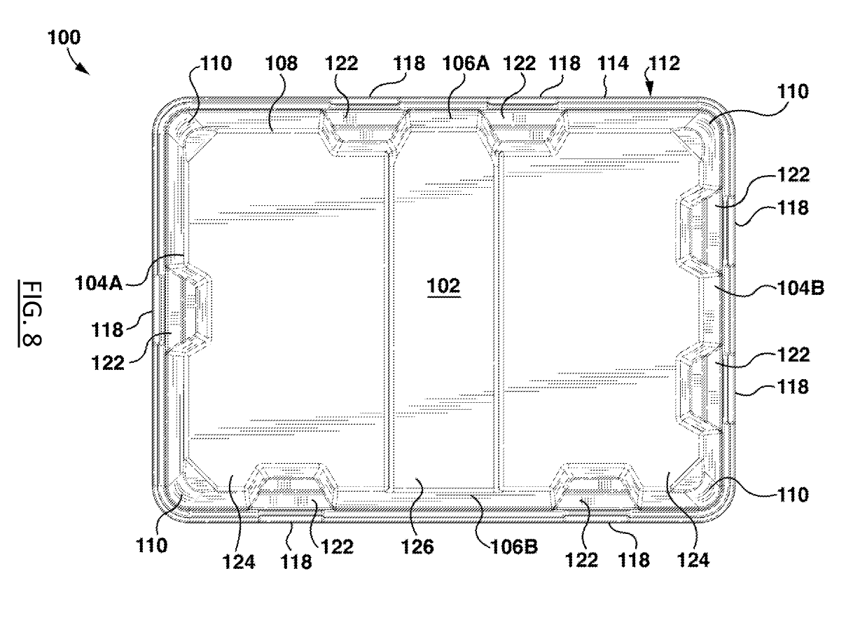

Reference is now made to FIGS. 1 to 8, which show an exemplary container according to an aspect of the present disclosure, indicated generally by reference 100. The container 100 comprises a base 102 and four container sidewalls 104A, 104B, 106A, 106B extending generally superiorly from the base 102 about a perimeter 108 thereof. In the exemplary embodiment shown in the Figures, the perimeter 108 of the base 102 of the container 100 is generally rectangular and there are four container sidewalls 104A, 104B, 106A, 106B connected by curved corners 110 so as to define and encircle an interior volume 120 of the container 100. More particularly, there are two relatively shorter container sidewalls 104A, 104B and two relatively longer container sidewalls 106A, 106B. In other embodiments, the sidewalls may be of equal length so that the rectangular perimeter is a square perimeter. In other embodiments, the perimeter of the base of the container may have other shapes and there may be more or fewer sidewalls. For example, and without limitation, the perimeter of the base may be a hexagon and there may be six container sidewalls, or the perimeter of the base may be circular or oval and there may be only a single continuous container sidewall.

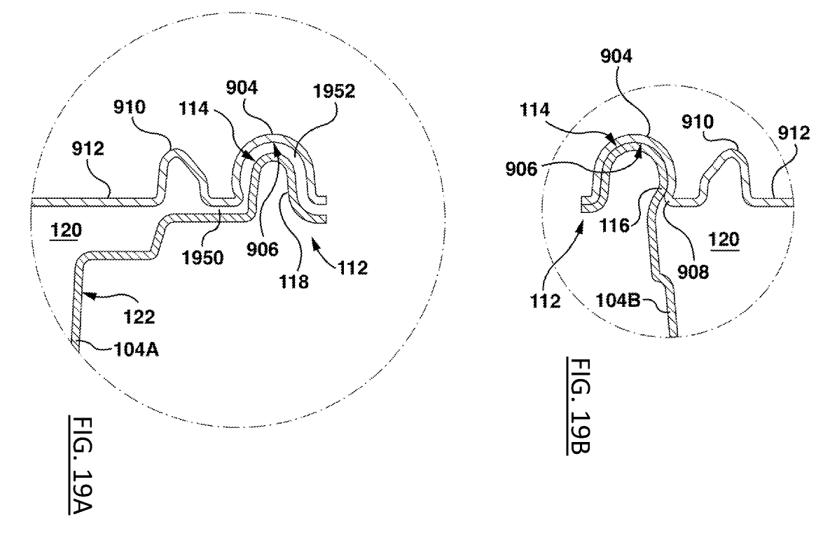

As best seen in FIGS. 19A and 19B, the container sidewalls have a peripheral edge structure 112 defining a hollow, outwardly-extending arch-shaped lid engagement lip 114 adapted for releasably securing a lid on the container 100.

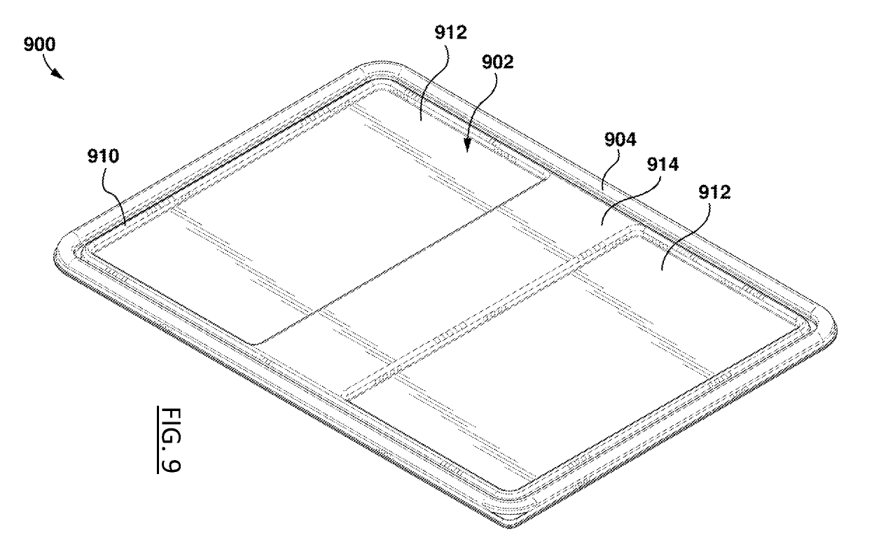

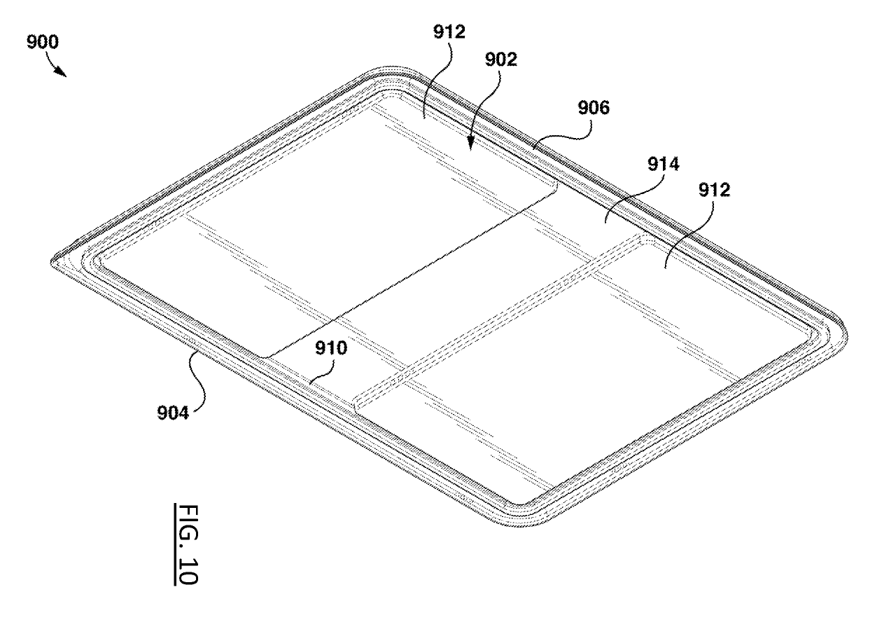

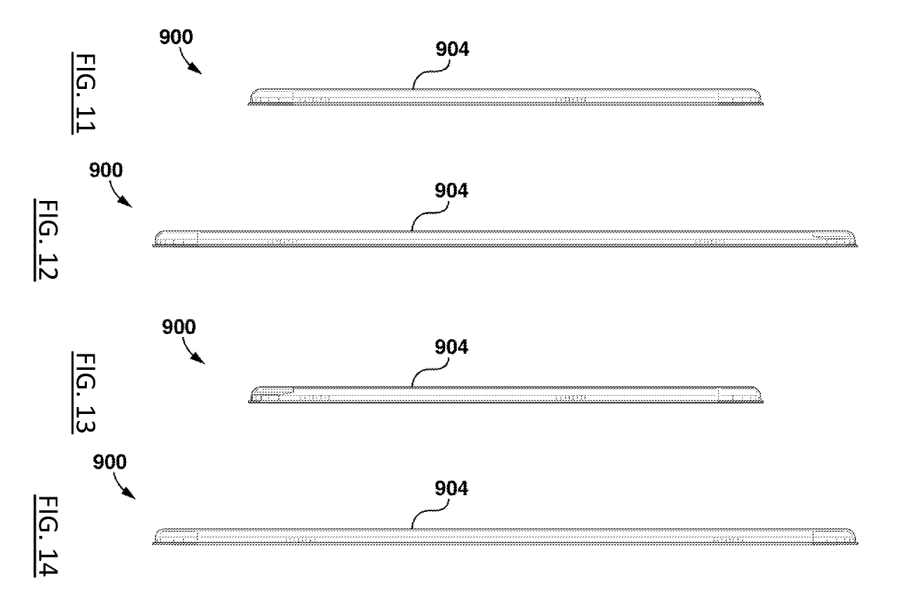

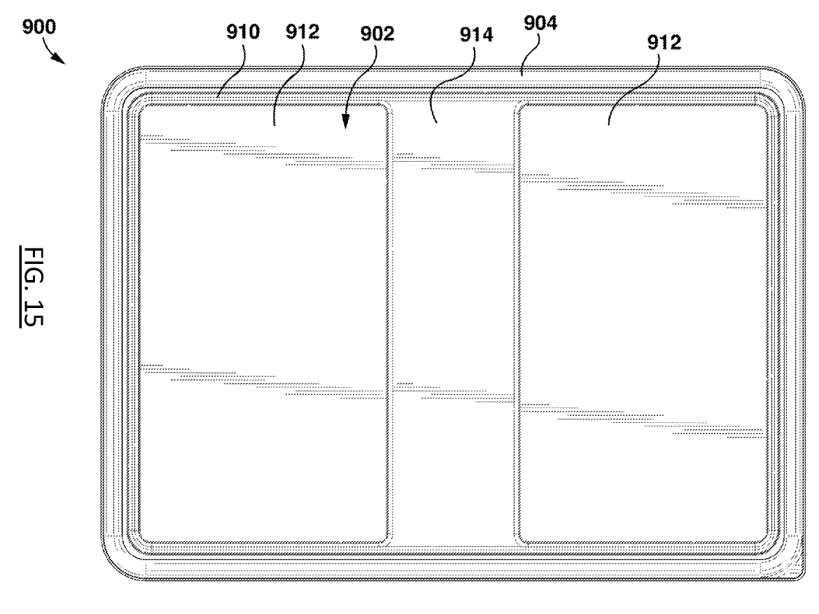

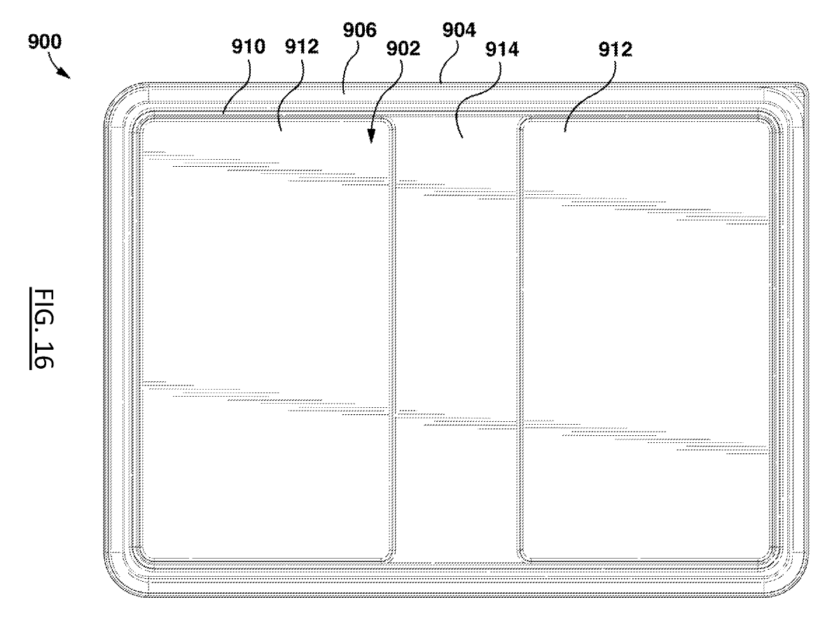

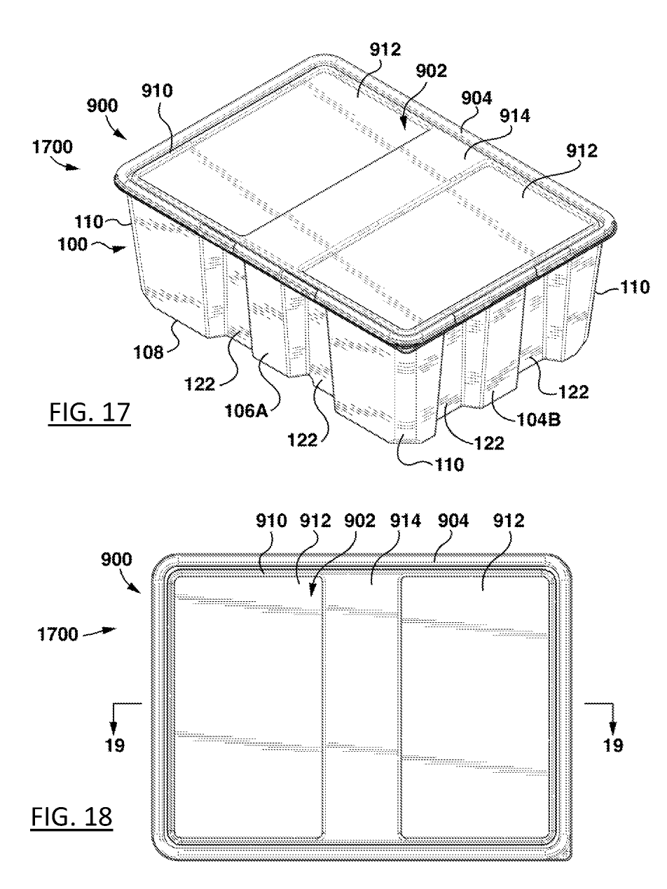

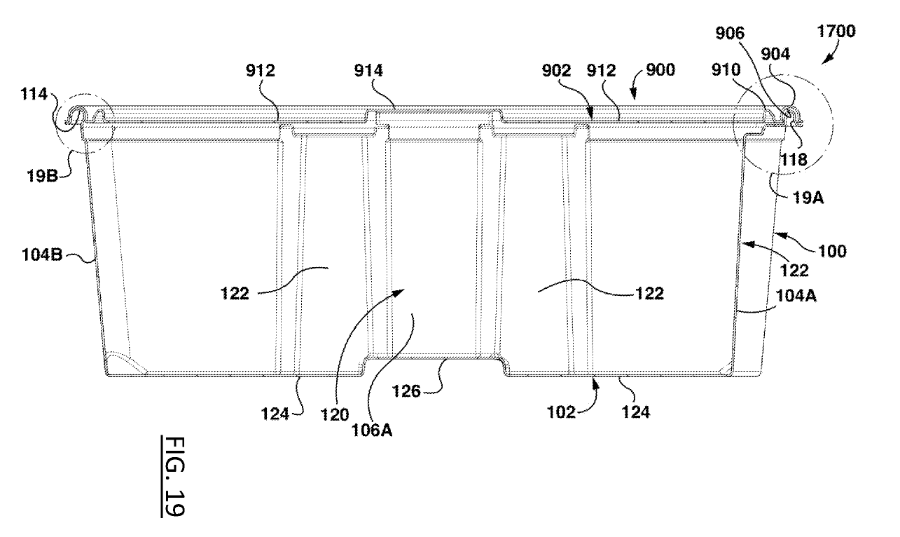

Reference is now made to FIGS. 9 to 16, in which an exemplary lid is indicated generally at reference 900. The lid 900 comprises a cover portion 902 and has a peripheral edge structure 904 defining a container engagement channel 906 (see FIGS. 10, 16 and 19 to 19B) extending about a perimeter of the cover portion 902, and includes a hollow ridge 910 formed inwardly of the container engagement channel 906 and extending around the cover portion 902. The size and shape of the lid engagement lip 114 on the container 100 and the size and shape of the container engagement channel 906 on the lid 900 are complementary to one another such that the lid 900 is releasably securable to the container 100 by releasable interengagement of the lid engagement lip 114 in an interference fit within the container engagement channel 906. Once a container 100 has been filled (e.g. with mushrooms), it can be closed by securing a lid 900 thereto to form a container and lid assembly 1700 as shown in FIGS. 17 and 18.

In the illustrated embodiment, as shown in FIG. 19B, the interference fit between the lid engagement lip 114 and the container engagement channel 906 is achieved by way of a channel shoulder 908 that projects inwardly into the container engagement channel 906 (outwardly from the cover portion 902) to overlap a correspondingly positioned lip shoulder 116 projecting inwardly relative to the container 100. This is merely one exemplary type of interengagement, and other suitable types of interengagement may equivalently be used.

In the illustrated embodiment, several perimetrically extending portions 118 of the lid engagement lip 114 are inwardly recessed. Thus, as seen in FIG. 19A, when the lid engagement lip 114 is interengaged with the container engagement channel 908, the lid engagement lip 114 and the container engagement channel 908 are spaced from one another at the inwardly recessed portions 118 of the lid engagement lip 114 to thereby form at least one ventilation pathway 1950 between the interior volume 120 of the container 100 and ambient. As can be seen, the ventilation pathway 1950 includes a circuitous, indirect, labyrinthine portion 1952 formed by the curved shape of the lid engagement lip 114 and the curved shape of the container engagement channel 908. Although in the illustrated embodiment the circuitous, indirect, labyrinthine portion 1952 of the ventilation pathway 1950 is curved, in other embodiments it may be formed from a series of non-parallel straight edges (e.g. where the lid engagement lip and the container engagement channel are similarly formed from complementary non-parallel straight edges rather than being curved) or may have other suitable shapes.

As noted above, in the illustrated embodiment the perimeter 108 of the base 102 of the container 100 is generally rectangular and there are two relatively shorter container sidewalls 104A, 104B and two relatively longer container sidewalls 106A, 106B. In the illustrated embodiment, the inwardly recessed perimetrically extending portions 118 of the lid engagement lip 114 on opposite sides of the container 100 are offset from one another. Thus, the single inwardly recessed perimetrically extending portion 118 on one of the relatively shorter container sidewalls 104A is disposed between, and hence offset from, two inwardly recessed perimetrically extending portions 118 on the opposite one of the relatively shorter container sidewalls 104B. Similarly, while both of the relatively longer container sidewalls 106A, 106B have two inwardly recessed perimetrically extending portions 118, the two inwardly recessed perimetrically extending portions 118 on one of the relatively longer container sidewalls 106A are disposed between, and hence offset from, the two inwardly recessed perimetrically extending portions 118 on the opposite one of the relatively longer container sidewalls 106B. As can he seen in the Figures, each of the container sidewalls 104A, 104B, 16A, 106B includes inwardly impressed strengthening columns 122, and the inwardly recessed portions 118 of the lid engagement lip 114 are in registration with the strengthening columns 122.

While the exemplary embodiment shows multiple inwardly recessed perimetrically extending portions 118 of the lid engagement lip 114, in other embodiments there may be only a single inwardly recessed perimetrically extending portion so long as sufficient ventilation is provided. Moreover, in other embodiments one or more perimetrically extending portions of the container engagement channel on the lid may be outwardly recessed so as to be spaced from the lid engagement lip to create one or more ventilation pathways. One or more perimetrically extending portions of the container engagement channel may he outwardly recessed either instead of or in addition to perimetrically extending portions of the lid engagement lip being inwardly recessed. Where perimetrically extending portions of both the container engagement channel and the lid engagement lip are recessed, those portions may be in registration with one another or offset from one another. Thus, the present disclosure contemplates that for at least one of the lid engagement lip and the container engagement channel, at least one perimetrically extending portion is recessed so that, when the lid engagement lip is interengaged with the container engagement channel, the lid engagement lip and the container engagement channel are spaced from one another at each such perimetrically extending portion to thereby form at least one ventilation pathway between an interior volume of the container and ambient.

In the illustrated embodiment, neither the container 100 nor the lid 900 include any vents or other openings formed therethrough. Thus, the cover portion 902 of the lid 900 omits any apertures therethrough and the base 102, container sidewalls 104A, 104B, 106A, 106B and corners 110 also omit any apertures therethrough. Ventilation of the container and lid assembly 1700 is provided only by the lid engagement lip and the container engagement channel being spaced from one another at one or more perimetrically extending portions so that the spacing forms one or more ventilation pathways between the interior volume of the container and ambient. The absence of vents or other apertures is a preferred embodiment because this assists in protecting the contents of the container from harm, for example from a foreign object entering the container through a ventilation aperture. Moreover, because the ventilation pathway 1950 includes a circuitous, indirect, labyrinthine portion 1952, ingress of foreign objects through the ventilation pathway 1950 is inhibited while still permitting off-gasses (e.g. carbon dioxide) to escape from the interior volume 120 of the container 100.

As can be seen in the drawings, in the illustrated embodiment the container 100 is designed to be stackable on the lid 900, so that once a container 100 has been filled (e.g. with mushrooms) and closed by securing a lid 900 thereto to form a container and lid assembly 1700 as shown in FIG. 17, another container 100 can be stacked on top of the assembly 1700. To facilitate stacking, in the illustrated embodiment the cover portion 902 of the lid 900 includes two spaced apart locating depressions 912 separated by a spacing ridge 914, and the base 102 of the container 100 includes two locating projections 124 separated by a spacing channel 126. The locating depressions 912 in the cover portion 902 of the lid 900 correspond in size, shape and position to the locating projections 124 on the base 102 of the container 100, and likewise the spacing ridge 914 on the cover portion 902 of the lid 900 corresponds in size, shape and position to the spacing channel 126 in the base 102 of the container 100. When a container 100 is stacked on a lid 900, the locating projections 124 on the base 102 of the container 100 are received in the locating depressions 912 in the cover portion 902 of the lid 900 and the spacing ridge 914 in the cover portion 902 of the lid 900 is received in the spacing channel 126 in the base 102 of the container 100. This arrangement inhibits the container 100 from sliding off the base 900. While the exemplary embodiment has the locating projections 124 on the base 102 of the container 100 and has the locating depressions 912 in the cover portion 902 of the lid 900, this is merely one exemplary implementation. In other implementations, the locating projections could be on the cover portion of the lid and the locating depressions could be formed in the base of the container. Thus, either the cover portion of the lid or the base of the container may include locating depressions and the other of the cover portion of the lid and the base of the container may include correspondingly positioned locating projections, with the locating depression configured to receive the locating projections therewithin. In still further embodiments, both the cover portion of the lid and the base of the container may include both locating depressions and locating projections. In this regard, the spacing ridge 914 may be considered as a locating depression and the spacing channel 126 may be considered a locating depression.

As will be apparent from the drawings, the container 100 is nestable within another of the containers 100, and the lid 900 is nestable within another of the lids 900, so as to facilitate shipping of the containers 100 and lids 900 to the location where they will be filled.

One or more currently preferred embodiments have been described by way of example. It will be apparent to persons skilled in the art that a number of variations and modifications can be made without departing from the scope of the claims.

What is claimed is:

1. A container and lid assembly, comprising;
a container, the container comprising:
a base;
the perimeter of the base being generally rectangular;
four container sidewalls extending generally superiorly from the base about a perimeter thereof and joined by corners to define and encircle an interior volume of the container;
the container sidewalls having a peripheral edge structure defining a lid engagement lip; and
a lid, the lid comprising:
a cover portion;
the cover portion having a peripheral edge structure defining a container engagement channel about a perimeter thereof; and
a ridge formed in the cover portion inwardly of the container engagement channel;
the lid being releasably securable to the container by releasable interengagement of the lid engagement lip in an interference fit within the container engagement channel;
wherein the interference fit is achieved by way of a channel shoulder that projects inwardly into the container engagement channel, outwardly from the cover portion, to overlap a correspondingly positioned lip shoulder projecting inwardly relative to the container;
and wherein:
on each of the container sidewalls, at least one portion of the perimetrically extending portion of the lid engagement lip is inwardly recessed so that, when the lid engagement lip is interengaged with the container engagement channel, the lid engagement lip and the container engagement channel are spaced from one another at each such perimetrically extending portion to thereby form at least one ventilation pathway between the interior volume of the container and ambient;
the at least one ventilation pathway includes a circuitous, indirect, labyrinthine portion formed by the respective shapes of the lid engagement lip and the container engagement channel;
the inwardly recessed perimetrically extending portions of the lid engagement lip on opposite sides of the container are offset from one another;
the container sidewall includes inwardly impressed strengthening columns on each side thereof; and
the inwardly recessed perimetrically extending portions of the lid engagement lip are in registration with the strengthening columns;
and wherein:
the container is stackable on the lid;
one of the cover portion of the lid and the base of the container includes locating depressions;
the other of the cover portion of the lid and the base of the includes correspondingly positioned locating projections; and
the locating depressions are configured to receive the locating projections therewithin.
and wherein the container is nestable within another of the containers.

2. A container and lid assembly, comprising:
a container, the container comprising:
a base;
at least one container sidewall extending generally superiorly from the base about a perimeter thereof to define and encircle an interior volume of the container;
the at least one container sidewall having a peripheral edge structure defining a lid engagement lip; and
a lid, the lid comprising:
a cover portion;
the cover portion having a peripheral edge structure defining a container engagement channel about a perimeter thereof;
the lid being releasably securable to the container by releasable interengagement of the lid engagement lip in an interference fit within the container engagement channel;
wherein, for at least one of the lid engagement lip and the container engagement channel, at least one perimetrically extending portion is recessed so that, when the lid engagement lip is interengaged with the container engagement channel, the lid engagement lip and the container engagement channel are spaced from one another at each such perimetrically extending recessed portion to thereby form at least one ventilation pathway between the interior volume of the container and ambient.

3. The container and lid assembly of claim 2, wherein at least one portion of the perimetrically extending portion of the lid engagement lip is inwardly recessed.

4. The container and lid assembly of claim 3, wherein:
the perimeter of the base is generally rectangular;
there are four container sidewalls joined by corners; and
at least one portion of the perimetrically extending portion of the lid engagement lip is inwardly recessed on each container sidewall.

5. The container and lid assembly of claim 4, wherein the inwardly recessed perimetrically extending portions of the lid engagement lip on opposite container sidewalls are offset from one another.

6. The container and lid assembly of claim 5, wherein:
the container includes inwardly impressed strengthening columns on each container sidewall; and
the inwardly recessed perimetrically extending portions of the lid engagement lip are in is registration with the strengthening columns.

7. The container and lid assembly of claim 2, wherein the container is stackable on the lid.

8. The container and lid assembly of claim 7, wherein:
one of the cover portion and the base includes locating depressions;
the other of the cover portion and the base includes correspondingly positioned locating projections; and
the locating depressions are configured to receive the locating projections therewithin.

9. The container and lid assembly of claim 2, wherein the container is nestable within another of the containers.

10. The container and lid assembly of claim 2, wherein the lid includes a ridge formed inwardly of the container engagement channel.

11. The container and lid assembly of claim 2, wherein the interference fit is achieved by way of a channel shoulder that projects inwardly into the container engagement channel, outwardly from the cover portion, to overlap a correspondingly positioned lip shoulder projecting inwardly relative to the container.

12. The container and lid assembly of claim 2, wherein the at least one ventilation pathway includes a circuitous, indirect, labyrinthine portion formed by respective shapes of the lid engagement lip and the container engagement channel.

13. A container, comprising:
a base;
at least one container sidewall extending generally superiorly from the base about a perimeter thereof to define and encircle an interior volume of the container;
the at least one container sidewall having a peripheral edge structure defining a lid engagement lip;
the container being releasably securable to a lid by releasable interengagement of the lid engagement lip in an interference fit within a container engagement channel on the lid;
wherein at least one portion of the perimetrically extending portion of the lid engagement lip is inwardly recessed so that, when the lid engagement lip is interengaged with the container engagement channel, the lid engagement lip and the container engagement channel are spaced from one another at each such perimetrically extending portion to thereby form at least one ventilation pathway between an interior volume of the container and ambient.

14. A container and lid assembly, comprising:
the container of claim 13; and
a lid, the lid comprising a cover portion and having a peripheral edge structure defining the container engagement channel about a perimeter thereof.

15. The container of claim 13, wherein
the perimeter of the base is generally rectangular;
there are four container sidewalls joined by corners; and
at least one portion of the perimetrically extending portion of the lid engagement lip is inwardly recessed on each container sidewall.

16. The container of claim 15, wherein the inwardly recessed perimetrically extending portions of the lid engagement lip on opposite container sidewalls are offset from one another.

17. The container of claim 16, wherein:
the container includes inwardly impressed strengthening columns on each container sidewall; and
the inwardly recessed perimetrically extending portions of the lid engagement lip are in registration with the strengthening columns.

18. The container of claim 13, wherein the base of the container includes at least one of locating depressions and locating projections.

19. The container of claim 18, wherein the base of the container includes locating projections.

20. The container of claim 13, wherein the container is nestable within another of the containers.
